(19) United States
(12) Patent Application Publication
(10) Pub. No.: US 2005/0097235 A1
(43) Pub. Date: May 5, 2005

(54) Systems and methods for providing printer information to a user

(76) Inventor: Dave R. Dehart, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/700,132

(22) Filed: Nov. 3, 2003

(51) Int. Cl. G06F 3/00

(52) U.S. Cl. 710/15

(57) ABSTRACT

Systems for providing printer information to a user are provided. In this regard, an exemplary system comprises a link display system. The link display system is operative to display a link to a Web page to a user in response to a user input. The link is displayed in association with a dialog box, and the Web page comprises information corresponding to the printer being used by the user. In response to the user actuating the link, the user is provided with the information corresponding to the printer. Methods and other systems also are provided.

### TECHNICAL FIELD

The present invention generally relates to printers.

### DESCRIPTION OF THE RELATED ART

Printers are peripheral devices commonly used with computer systems. Although commonplace, there are numerous types and models of printers. Because different models of printers tend to function differently, support documentation typically is provided with each printer.

Typically, support documentation is provided in the form of a hardcopy document, such as a support manual. Such a support manual usually is provided in the packaging used to ship the printer. Support documentation can be referred to by a user when the user experiences a problem with the printer. However, because locating the provided support documentation oftentimes cannot be accomplished quickly, a user may resort to calling a product support center associated with the printer when experiencing a problem.

Typically, a product support center is staffed by telephone operators that assist the user in troubleshooting a problem. Unfortunately, the manufacturer of the printer typically must bear the cost of providing a product support center. As should be understood, this can increase the cost of printers.

### SUMMARY

Systems and methods for providing printer information to a user are provided. In this regard, an embodiment of a system comprises a link display system. The link display system is operative to display a link to a Web page to a user in response to a user input. The link is displayed in association with a dialog box, and the Web page comprises information corresponding to the printer being used by the user. In response to the user actuating the link, the user is provided with the information corresponding to the printer.

An embodiment of a method comprises: displaying a dialog box to a user in response to a user input, the dialog box including a link to a Web page, the Web page comprising information corresponding to the printer being used by the user; and in response to the user actuating the link, providing the user with the information corresponding to the printer.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a schematic diagram depicting an embodiment of a system for providing printer information to a user.

FIG. 2 is a flowchart depicting an embodiment of a method for providing printer information to a user.

FIG. 3 is a schematic diagram of a computer or processor-based device that can be used to implement a method for providing printer information to a user.

FIG. 4 is a flowchart depicting functionality of an embodiment of a link display system.

FIG. 5 is an embodiment of a dialog box of a system for providing printer information to a user.

FIG. 6 is a screen shot of the dialog box of FIG. 5, depicting a list of printers from which the user may select for printing.

FIG. 7 is a screen shot of the dialog box of FIGS. 5 and 6, after the user has selected another printer.

FIG. 8 is a screen shot of the dialog box of FIGS. 5-7, depicting pages displayed to the user upon actuation of the Properties actuator.

FIG. 9 is a screen shot of the dialog box of FIGS. 5-8, depicting the support manual page.

### DETAILED DESCRIPTION

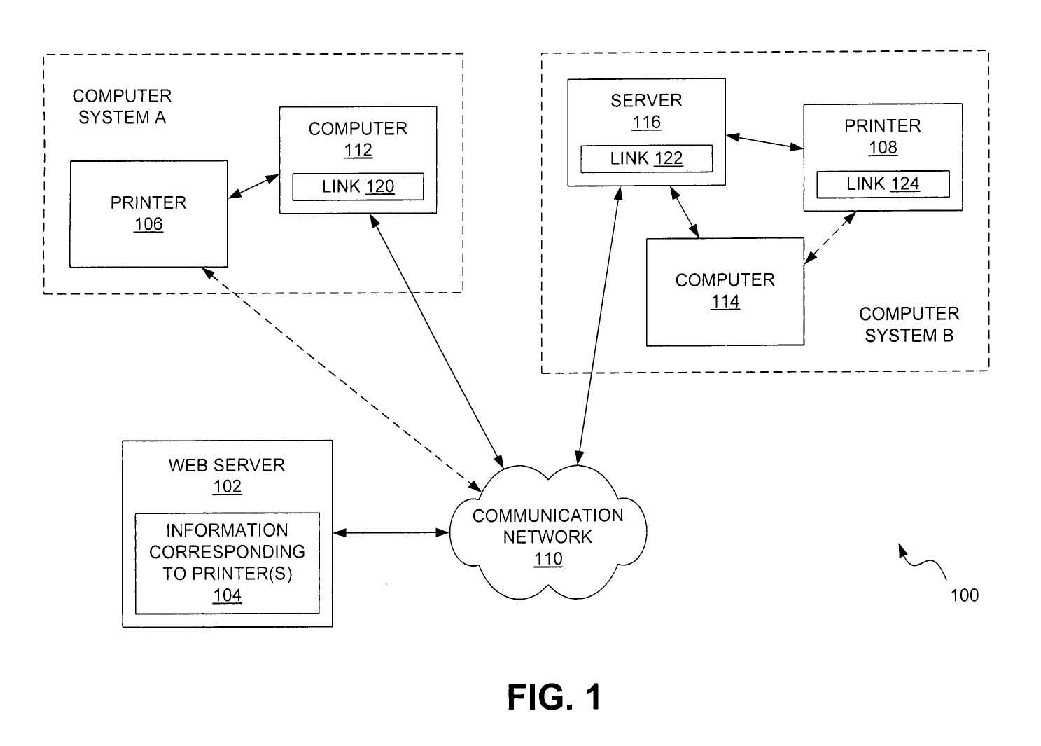

As will be described in detail here, systems and methods are provided that can provide a user with access to printer information in a manner that is potentially more efficient than is conventionally accomplished. By way of example, some embodiments provide a link, e.g., an Internet hyperlink, that is automatically displayed to a user when a print dialog box is displayed. Thus, if the user is experiencing difficulty in performing a print operation, the user will have ready access to the link which, upon actuation, directs the user to web-based information corresponding to their printer. An embodiment of a printer information system will now be described with respect to FIG. 1.

As shown in FIG. 1, printer information system 100 incorporates a web server 102 that includes information corresponding to one or more printers. In this case, web server 102 includes information 104 corresponding to printers 106 and 108. By way of example, the information 104 can relate to operating procedures, troubleshooting procedures and/or other information, such as that typically provided by a printer support manual. The information 104 is provided in a format that is accessible via a communication network. For instance, the information can be provided in HTML format and can be accessible via the Internet.

In the embodiment of FIG. 1, web server 102 and information 104 corresponding to printers 106 and 108 can be accessed via communication network 110. The communication network 110 enables computer system A, which includes computer 112 and printer 106, and a computer system B, which includes computer 114, printer 108 and server 116, to communicate with web server 102. Note that computer systems A and B are representative examples of computer systems that can communicate with web server 102. It should be understood that other computer systems, which may be provided in various other configurations, also can be used.

Referring now in detail to computer system A, computer 112 communicates directly with communication network 110. Computer 112 also communicates with printer 106. Note that, in some embodiments, printer 106 also can have a direct communication link to communication network 110, as indicated by the dashed line. Computer 112 incorporates a link 120 that includes information for enabling a user to access the information 104 corresponding to printer 106, and which is stored in web server 102. By way of example, link 120 can be a hyperlink that is displayed to the user when operating computer 112. Thus, by actuating the hyperlink, communication between computer 112 and web server 102 is established via communication network 110. This enables the information 104 corresponding to printer 106 to be displayed to the user via a display device of computer 112.

Referring now to computer system B, computer system B includes a server 116 that communicates directly with communication network 110. Such a server could have multiple workstations associated therewith; however, in this embodiment, only one computer is depicted. Server 116 also communicates with computer 114 and with a printer 108. Note that there is no direct communication between computer 114 and printer 108, although, in other embodiments, such a direct communication link could be provided.

In contrast to computer 112, computer 114 does not locally store a link to information 104 corresponding to printer 108. In particular, information corresponding to such a link 122 is stored at the server 116. Note that, in this embodiment, information corresponding to a link, e.g., link 124, also is stored locally at printer 108. In operation, when the user of computer 114 desires information corresponding to printer 108, the information can be acquired by accessing the information corresponding to the link that is stored at the server and/or the printer.

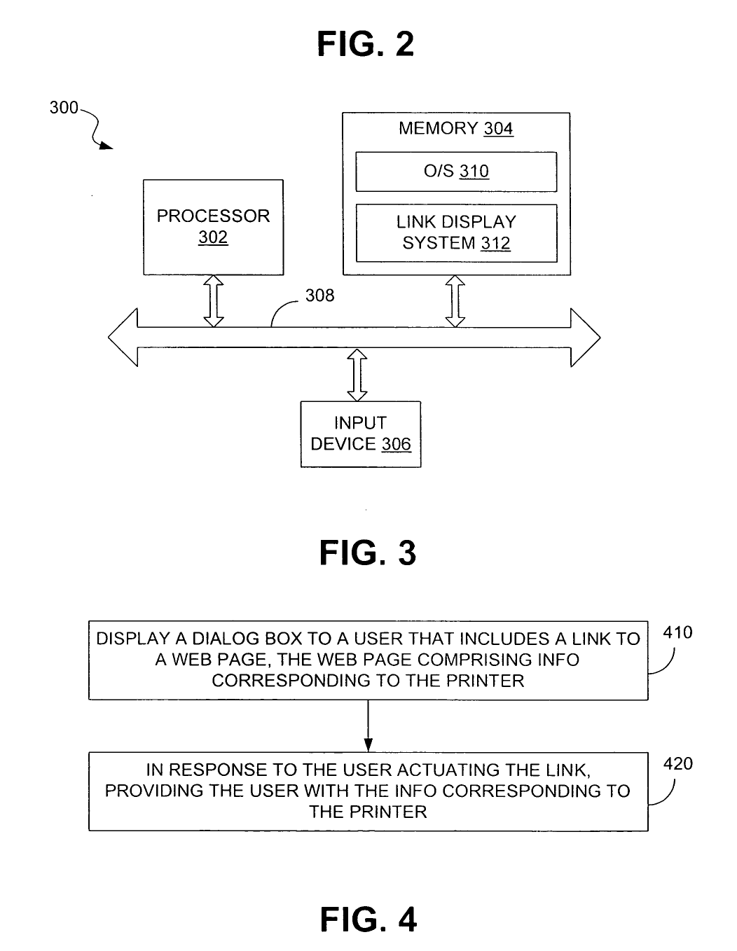

An embodiment of a method for providing printer information to a user is depicted in the block diagram of FIG. 2. As shown in FIG. 2, the method includes providing information corresponding to a link to a user of a printer. Specifically, the link corresponds to a web site that comprises information corresponding to the printer. By way of example, the information can correspond to that which is typically provided in a support manual associated with the printer. By providing access to such information via a link, it may be possible, in some embodiments, to forego providing such information in hardcopy format to the user. That is, the conventional practice of providing a support manual or other documentation in a shipping container that is used to ship the printer may be omitted, because the user now can be provided with more convenient access to the information via use of the link. Additionally or alternatively, information provided on a computer-readable medium, such as a CD can be omitted from the packaging. Thus, production costs of printers potentially can be reduced.

Advantageously, by providing a link to information that is stored remotely, the information can be updated as needed to support the product. This is in contrast to providing a hardcopy that typically is updated by a replacement version and subsequent mailing of the hardcopy to the user.

As will be described in detail here, the exemplary functionality described with respect to the block diagram of FIG. 2 can be implemented in hardware, software, firmware and/or combinations thereof. Reference will now be made to an embodiment of a system that is implemented in software and executed by a computer. In this regard, FIG. 3 is a schematic diagram of a representative computer that can be used for implementing an embodiment of a link display system for providing the aforementioned functionality.

Generally, in terms of hardware architecture, computer 300 includes a processor 302, memory 304, and one or more input and/or output (I/O) devices 306 that are communicatively coupled via a local interface 308. The software in memory 304 can include one or more separate programs, each of which comprises an ordered listing of executable instructions for implementing logical functions. In the example of FIG. 3, the software in the memory 304 includes an operating system (O/S) 310 and an embodiment of a link display system 312.

When link display system 312 is implemented in software, it should be noted that the link display system can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. The link display system 312 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

A computer-readable medium can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Functionality of the embodiment of the link display 312 of FIG. 3 is presented in the flowchart of FIG. 4. It should be noted that, in some alternative implementations, the functions noted in the various blocks of this and/or other flowcharts depicted in the accompanying disclosure may occur out of the order depicted. For example, two blocks shown in succession in FIG. 4 may be performed concurrently, or in reverse order depending upon the functionality involved.

As shown in FIG. 4, the functionality (or method) may be construed as beginning at block 410, where a dialog box is displayed to the user. For example, the dialog box can include a link to a web page, with the web page comprising information corresponding to a printer about which the user desires information. In block 420, the user is provided with the information corresponding to the printer in response to the user actuating the link.

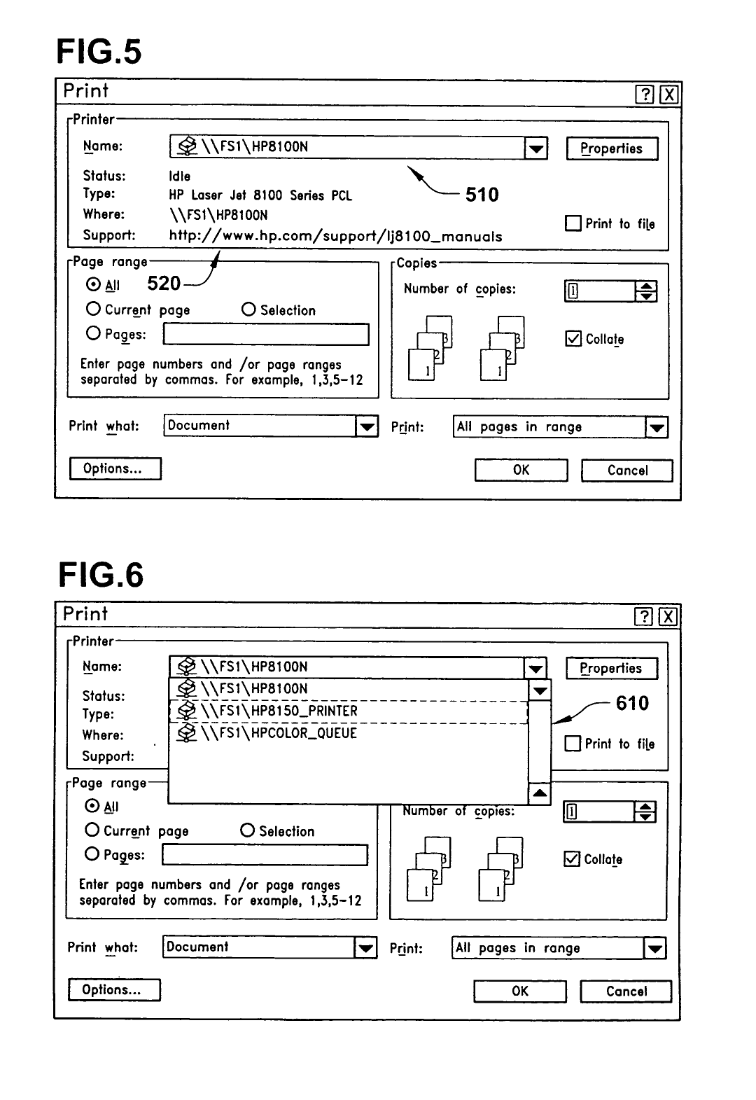

Reference will now be made to multiple representative screen shots that depict examples of dialog boxes that can be displayed to a user by an embodiment of a system for providing print information. As shown in FIG. 5, a representative printer dialog box 500 is displayed that includes various information about a printer that is being used by a user. By way of example, such a print dialog box can be displayed to a user when operating a word processing program when the print icon and/or file/print is selected. Note that the print dialog box identifies the currently-selected printer, which is indicated in the name field 510. Also note that a link is displayed in support field 520. By actuating this link, information corresponding to the currently-selected printer is provided to the user by establishing communication that permits access to information stored at a web site.

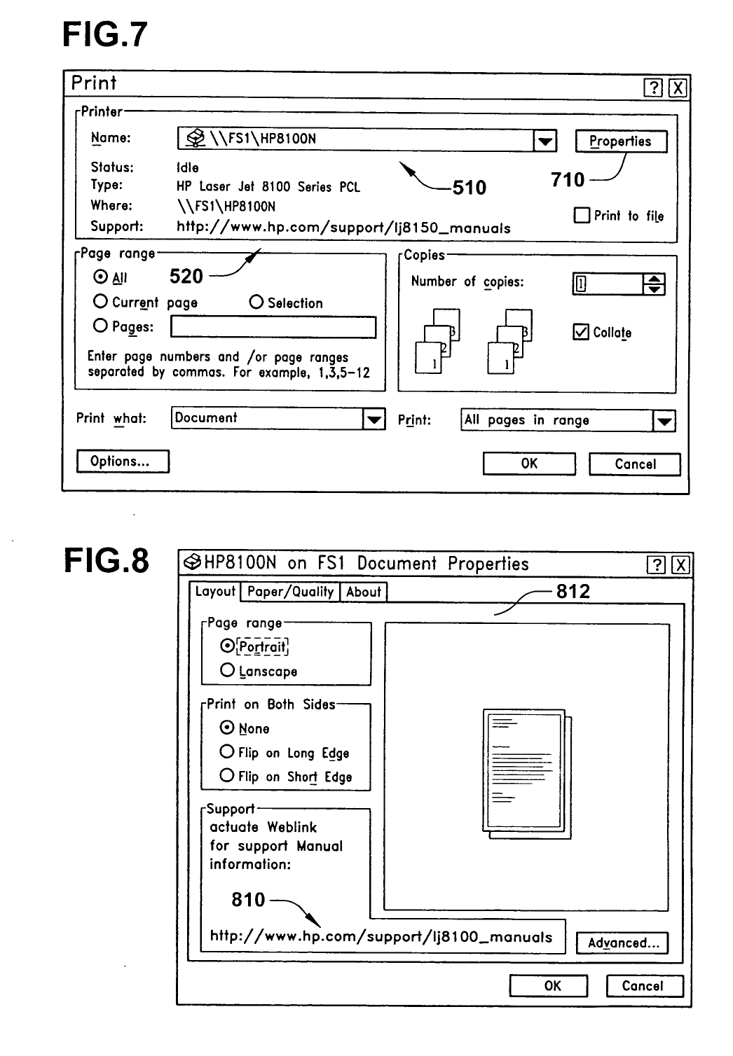

As depicted in FIG. 6, the user has opened a drop-down menu 610 and has highlighted another printer for use. In this case, the user has highlighted printer HP8150. Upon selection of the HP8150 printer, that printer is now designated for use and is indicated in the name field 510 of FIG. 7. Note also that the link displayed in the support field 520 has changed to correspond to the newly-selected printer.

In some embodiments, in addition to or in lieu of a link being displayed on the first page of the printer dialog box, a link may be displayed on another page. By way of example, such a link could be provided on one or more of the pages that are displayed to the user upon actuating the Properties actuator 710.

In some embodiments, upon actuating a Properties actuator of a print dialog box, information such as that depicted in FIG. 8 may be displayed to the user. Preferably, a link to information corresponding to a printer can be displayed on the first page displayed to the user upon actuation of the Properties actuator. This is depicted in FIG. 8, in which link 810 is provided on the layout page 812.

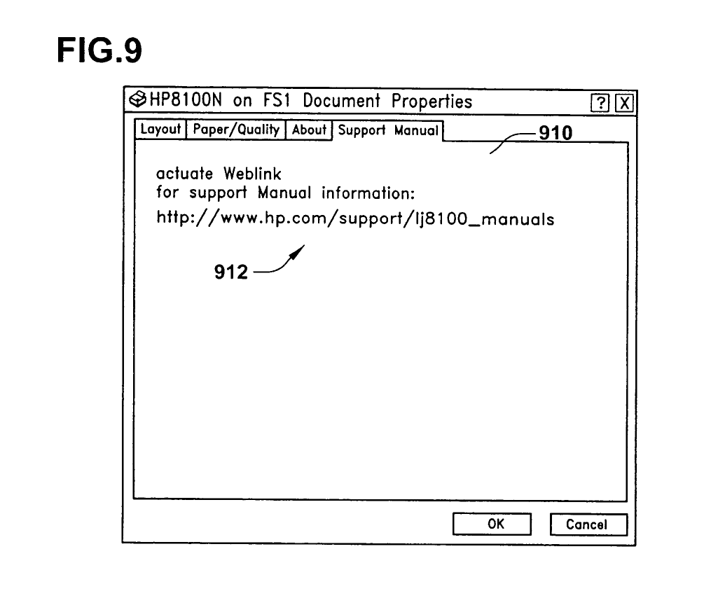

In other embodiments, such as depicted in FIG. 9, an additional page can be added to the Properties pages. For instance, as shown in FIG. 9, a support manual page 910 has been added. This support manual page includes a link 912 to the support information corresponding to the selected printer.

It should be emphasized that many variations and modifications may be made to the above-described embodiments. All such modifications and variations are intended to be included herein within the scope of this disclosure and protected by the following claims.

1. A method for providing printer information to a user, the method comprising:
displaying a dialog box to a user in response to a user input, the dialog box including a link to a Web page, the Web page comprising information corresponding to the printer being used by the user; and
in response to the user actuating the link, providing the user with the information corresponding to the printer.

2. The method of claim 1, wherein:
the dialog box comprises multiple pages; and
in displaying the dialog box to the user, the link is provided on a first of the pages that is displayed.

3. The method of claim 2, wherein the dialog box is a print dialog box.

4. The method of claim 3, wherein the print dialog box comprises a Properties actuator, which, in response to actuation thereof, displays multiple pages; and
the link is provided on a first of the pages displayed to the user in response to actuating the Properties actuator.

5. The method of claim 3, wherein the print dialog box comprises a Properties actuator, which, in response to actuation thereof, displays multiple pages; and
the link is provided on one of the pages displayed to the user in response to actuating the Properties actuator.

6. The method of claim 3, wherein the print dialog box comprises a Properties actuator, which, in response to actuation thereof, displays a Layout page, a Print Quality page, an About page and a Support Manual page; and
the link is provided on the Support Manual.

7. The method of claim 1, wherein the Web page comprises information corresponding to use manual of the printer.

8. The method of claim 1, wherein:
the method additionally comprises providing a list of printers from which the user is able to print, each of the printers having corresponding printer information associated therewith; and
in response to the user selecting one of the printers of the list, a corresponding link to a Web page that comprises the printer information associated with the printer selected is displayed.

9. A method for providing printer information to a user, the method comprising:
providing information corresponding to a link to a user of a printer, the link corresponding to a Web site, the Web site comprising information corresponding to the printer, the link being displayable to the user in response to a user input such that, in response to the user actuating the link, the user is provided with the information corresponding to the printer.

10. The method of claim 9, wherein, in providing information corresponding to a link to a user of a printer, the information is installed in the printer.

11. The method of claim 9, wherein, in providing information corresponding to a link to a user of a printer, the user installs the information in the printer.

12. The method of claim 9, wherein:
the Web site comprises multiple Web pages; and
the link corresponds to one of the Web pages that comprises information corresponding to a user manual of the printer.

13. The method of claim 9, wherein:
the user has access to multiple printers; and
the method further comprises:
providing the user with a link to a Web page that comprises printer information corresponding to one of the multiple printers currently selected by the user.

14. A system for providing printer information to a user, the system comprising:
a link display system operative to display a link to a Web page to a user in response to a user input, the link being displayed in association with a dialog box, the Web page comprising information corresponding to the printer being used by the user such that, in response to the user actuating the link, the user is provided with the information corresponding to the printer.

15. The system of claim 14, further comprising:
a computer system comprising:
a processor operative to execute instructions;
memory communicating with the processor and operative to store instruction executable by the processor; and
printer interface instructions stored by the memory, the printer interface instructions being operative to display a print dialog box to the user in response to a user input, the link being displayed in association with the print dialog box.

16. The system of claim 14, wherein:
the printer interface instructions are executable to display a list of printers with which the computer system has access, each of the printers having corresponding printer information associated therewith; and
in response to the user selecting one of the printers of the list, the link display system is operative to display a corresponding link to a Web page that comprises the printer information associated with the printer selected.

17. The system of claim 14, further comprising:
a printer communicating with the computer system.

18. The system of claim 14, wherein the link display system is stored by the printer.

19. The system of claim 14, wherein the link display system is stored by the computer system.

20. The system of claim 14, further comprising:
means for displaying the link.
